(19) United States
(12) Patent Application Publication
(10) Pub. No.: US 2011/0299280 A1
(43) Pub. Date: Dec. 8, 2011

(54) LIGHTING UNIT

(75) Inventor: Justin Maeers, Northants (GB)

(73) Assignee: Collingwood Lighting Limited, Northamptonshire (GB)

(21) Appl. No.: 13/127,929

(22) PCT Filed: Nov. 12, 2009
(86) PCT No.: PCT/GB2009/002651

§ 371 Date: Aug. 18, 2011

(30) Foreign Application Priority Data
Nov. 12, 2008 (GB) 0820680.7
Mar. 30, 2009 (GB) 0905440.4

(51) Int. Cl. F21V 29/00; F21V 21/00

(52) U.S. Cl. 362/249.02; 362/374

(57) ABSTRACT

A lighting unit includes a fire resistant housing (11) that is adapted to be mounted within an aperture in a partition (2). The housing (11) is made from a material that has a melting point in excess of 1000° C. and has a front side and a rear side. An LED lighting element (17) is mounted within the fire resistant housing on the front side thereof, and a heat sink (21) is mounted on the rear side of the fire resistant housing. The lighting element (17) and the heat sink are mounted in thermal contact with the fire resistant housing to dissipate heat generated in use by the lighting. Heat generated in use by the lighting element (17) is transferred by conduction to the heat sink (21) via the fire resistant housing (11).

The present invention relates to a lighting unit including a lighting element and a fire resistant housing that is adapted to be mounted in an aperture in a partition, for example a wall or ceiling panel. In particular, but not exclusively, the invention relates to a lighting unit including a light emitting diode (LED) lighting element.

With lighting units that include LED lighting elements it is important to prevent overheating of the element, as this can seriously affect both the light output and the service life of the element. Excessive temperatures can cause the electronic components within the lighting element to fail, thus causing premature failure of the lighting unit. It is common practice therefore to provide LED lighting units with cooling means, for example a heat sink and/or a fan, in order to dissipate heat generated in use by the lighting element.

Fire-rated lighting units are designed to be mounted within an aperture in a partition (for example a wall or a ceiling panel) that acts as a fire barrier. Such lighting units usually include a fire resistant housing that surrounds the light fitting. This fire resistant housing fits into the aperture of the partition and is designed to maintain the integrity of the fire bather, thereby preventing flames from passing through the barrier and entering the void behind the barrier in the event of a fire.

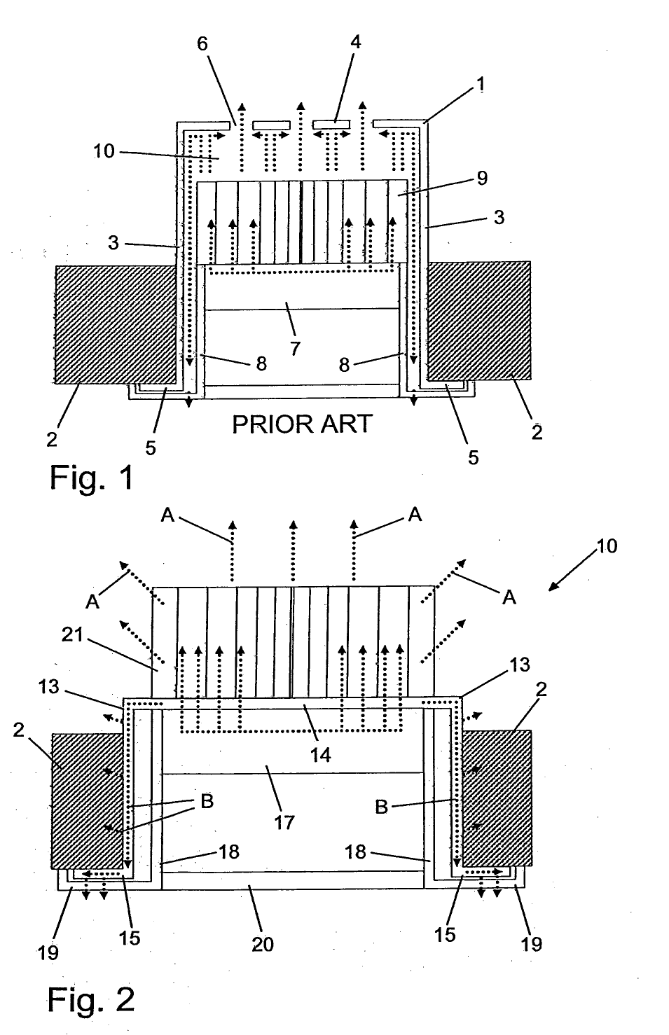

A typical LED lighting unit is shown in FIG. 1. This includes a fire resistant housing 1 made for example of pressed steel that fits into an aperture in a ceiling panel 2. In cross-section, the housing 1 resembles an open sided box having two side walls 3 and an upper end wall 4. A flange 5 extends outwards from the open lower end of the housing and engages the lower face of the partition 2. Ventilation holes 6 are provided in the upper end wall 4.

An LED lighting element 7 is attached to a trim element 8, made for example of aluminium, glass or a suitable plastics material, which is mounted within the fire resistant housing 1. A heat sink 9, for example an aluminium extrusion, is attached to the back of the lighting element 7 in thermal contact therewith. A void 10 is provided between the heat sink 9 and the upper end wall 4 of the housing.

In use, heat generated by the lighting element 7 is transferred by conduction into the heat sink 9 and is then dissipated by convection and radiation: However, this process is inefficient, as the housing 1 surrounds the heat sink and thus restricts the dissipation of heat, both by convection and by radiation. Convection is also restricted by the fact that the light fitting is effectively sealed at its front end, thereby preventing any flow of air through the fitting.

It is an object of the present invention to provide a lighting unit that mitigates at least some of the aforesaid disadvantages.

According to the present invention there is provided a lighting unit including a fire resistant housing that is adapted to be mounted within an aperture in a partition, said housing having a front side and a rear side, a lighting element mounted within the fire resistant housing on the front side thereof, and a heat sink for dissipating heat generated in use by the lighting element, wherein the lighting element is mounted in thermal contact with the fire resistant housing so that heat generated in use by the lighting element is transferred by conduction into the fire resistant housing, and the heat sink is mounted in thermal contact with the rear side of the fire resistant housing to dissipate heat from the fire resistant housing, the arrangement being such that heat generated in use by the lighting element is transferred by conduction to the heat sink via the fire resistant housing.

By fire resistant, it is meant that the fire resistant member is able to withstand specified temperatures for a specified period of time without failing, for example building regulations in the United Kingdom for some types of buildings require the lights to withstand temperatures of around 1000° C. For example, a current relevant standard is BSEN 1365-2:1999, which is the current European standard for fire rated ceilings. Other countries, or different types of buildings, may have different temperature ratings, such as 900° C. or 1100° C. The invention is particularly concerned with fire resistant members that can survive temperatures of around 1000° C.

The lighting unit is able to dissipate heat efficiently from the lighting element because the heat sink is mounted on the rear side of the fire resistant housing, rather than being located within the housing. Heat can therefore be dissipated efficiently from the lighting element by conduction and radiation, ensuring that the lighting element does not overheat. A reduction in the light output and the service life of the element is thus avoided. Furthermore, the fire resistance of the housing is not compromised.

Advantageously, the lighting element is a solid state lighting element, and preferably an LED lighting element.

The fire resistant housing preferably comprises an open sided box having side walls and an end wall. The fire resistant housing preferably includes a flange that extends outwardly from the side walls at the open side of the housing. The heat sink is preferably attached to the end wall of the fire resistant housing. Alternatively, the heat sink may be attached to another part of the housing, for example a side wall. Advantageously the fire resistant housing can be made from steel and preferably has a thickness in the range 0.3 to 2 mm. Use of this material for the fire resistant housing with a sufficient thickness provides the fire resistant quality.

The lighting unit may include a trim element. The trim element preferably covers the outwardly extending flange. Preferably, the trim element extends between the lighting element and the side walls of the fire resistant housing.

The lighting unit may include a transparent or translucent cover plate that extends across the open side of the fire resistant housing.

According to another aspect of the, invention, there is provided a method for preventing fire from penetrating a hole formed in a partition, said method including installing a lighting unit according to any configuration described herein to substantially plug and/or cover the aperture. Typically, the partition comprises a ceiling or a ceiling element such as a ceiling tile. Advantageously the lighting unit includes a fire resistant housing that is made from a material that does not melt at temperatures below 1000° C. The fire resistant housing is arranged such that the fire resistant housing does not fail when exposed to a temperature of around 1000° C. for a period of 90 minutes.

An embodiment of the invention will now be described by way of example, with reference to the accompanying drawings, wherein:

FIG. 1 is a cross-sectional side view through a prior art lighting unit, and

FIG. 2 is a cross-sectional side view through a lighting unit according to an embodiment of the invention.

A lighting unit 10 according to one embodiment of the invention is shown in FIG. 2. This lighting unit includes a fire resistant housing that fits into an aperture in a partition 2 (for example, a veiling panel). The housing 11 is made from a material having a melting point in excess of 1000° C., for example from a metal such as steel. Preferably the housing 11 is made from pressed steel, and typically has a thickness in the range 0.3 to 2 mm, such that the housing 3 will not melt at temperatures below 1000° C. In cross-section, the housing resembles an open sided box having two side walls 13 and an upper end wall 14. If the lighting unit is rectangular in plan view, the housing will also include two perpendicular walls (not shown), although it may of course take any convenient shape. The housing 11 thus has a front side that faces outwards and a rear side that faces inwards into the recess behind the partition 2. A flange 15 extends outwards from the open lower end of the housing and engages the lower face of the partition 2.

An LED lighting element 17, comprising for example one or more LEDs on an aluminium mounting plate, is attached to the lower face of the upper end wall 14 so that it is in good thermal contact therewith. A trim element 18 for example of glass, aluminium or a suitable plastics material is mounted within the fire resistant housing 11, between the side walls 13 and the LED lighting unit 17. At its lower end the trim element 18 includes an outwardly extending cover plate 19 that covers the flange 15. An optional glass cover plate 20 extends across the open side of the fire resistant housing 11.

A heat sink 21, for example an aluminium extrusion, is attached to the upper face of the end wall 14 on the rear side of the fire resistant housing 11, so that it makes good thermal contact with the fire resistant housing 11. The heat sink 21 extends upwards into the void behind the partition 2.

In use, heat generated by the LED lighting element 17 is transferred by conduction into the fire resistant housing 11 and then from the fire resistant housing 11 into the heat sink 21. The heat is then dissipated by convection and radiation into the void, as illustrated by the broken arrows (A). Some heat is also dissipated by conduction from the fire resistant housing 11 into the body of the partition 2 and into the interior of the room as indicated by the arrows (B). This arrangement ensures that heat is dissipated efficiently from the LED lighting unit 17, thus avoiding over-heating and ensuring a high light output and a long service life.

In the event of a fire, the LED lighting element 17, the trim element 18, 19 and the cover plate 20 may melt and fall out of the housing 11. However, the fire barrier formed by the partition 2 and the steel fire resistant housing 11 is not compromised for the period of its fire rating. For example, a ceiling may be rated at 90 minutes such as required by BSEN 1365-2:1999, that is, it is designed to survive for 90 minutes in the event of the fire. The material and thickness of the material for the fire resistant housing 9 is selected according to the rating of the ceiling. Typically the fire resistant housing 9 will be designed to withstand a temperature of around 1000° C. and will not fail in fires having a temperature below its design threshold.

It has been found that a housing made from steel having a thickness of at least 0.3 mm will withstand temperatures of around 1000° C. for a period of at least 90 minutes. Thus the lighting unit according to the invention has the advantage that it can meet current standards, while at the same time providing a simple structure that is relatively cheap to manufacture and relatively easy to install when compared with known fire resistant lighting units.

Typically the units according to the invention are also smaller and lighter than known fire resistant lighting units.

1. A lighting unit including a fire resistant housing that is adapted to be mounted within an aperture in a partition, said housing having a front side and a rear side, a solid state lighting element mounted within the fire resistant housing on the front side thereof, and a heat sink for dissipating heat generated in use by the solid state lighting element, wherein the solid state lighting element is mounted in thermal contact with the fire resistant housing so that heat generated in use by the solid state lighting element is transferred by conduction into the fire resistant housing, and the heat sink is mounted in thermal contact with the rear side of the fire resistant housing to dissipate heat from the fire resistant housing, the arrangement being such that heat generated in use by the solid state lighting element is transferred by conduction to the heat sink via the fire resistant housing.

2. A lighting unit according to claim 1, wherein the solid state lighting element includes at least one LED lighting element.

3. (canceled)

4. A lighting unit according to claim 1, wherein a wall of the fire resistant housing includes steel.

5. A lighting unit according to claim 1, wherein the fire resistant housing comprises an open sided box having side walls and an end wall.

6. A lighting unit according to claim 5, wherein the fire resistant housing includes a flange that extends outwardly from the side walls at the open side of the housing.

7. A lighting unit according to claim 5, in which the heat sink is attached to the end wall of the fire resistant housing.

8. A lighting unit according to claim 1 or claim 6, further comprising a trim element.

9. A lighting unit according to claim 8, wherein the trim element covers the outwardly extending flange.

10. A lighting unit according to claim 8, wherein the trim element extends between the lighting element and the side walls of the fire resistant housing.

11. A lighting unit according to claim 5, further comprising a transparent or translucent cover plate that extends across the open side of the fire resistant housing.

12. A partition including at least one lighting unit according to claim 1.

13. A method for preventing fire from penetrating a hole formed in a partition, said method including installing a lighting unit according to claim 1 to substantially plug and/or cover the aperture.

14. A lighting element according to claim 2, wherein the LED lighting element includes a mounting plate.

15. A lighting unit according to claim 1, wherein the fire resistant housing includes a material that melts at a temperature in excess of 900° C.

16. A lighting unit according to claim 15, wherein the fire resistant housing includes a material that melts at a temperature in excess of 1000° C.

17. A lighting unit according to claim 16, wherein the fire resistant housing includes a material that melts at a temperature in excess of 1100° C.

18. A lighting unit according to claim 1, wherein a wall of the fire resistant housing has a thickness of at least 0.3 mm.

19. A lighting unit according to claim 18, wherein the wall of the fire resistant housing has a thickness of less than or equal to 2 mm.

20. A lighting unit according to claim 1, wherein the fire resistant housing includes sheet material.

21. A lighting unit according to claim 1, wherein the fire resistant housing is pressed.
